(19) United States
(12) Patent Application Publication
(10) Pub. No.: US 2024/0164869 A1
(43) Pub. Date: May 23, 2024

(54) SURGICAL GUIDE FOR PLACING DENTAL IMPLANTS

(71) Applicant: BIOTECH DENTAL, Salon-de-Provence (FR)

(72) Inventor: Pierre KELLER, Strasbourg (FR)

(21) Appl. No.: 18/516,144

(22) Filed: Nov. 21, 2023

(30) Foreign Application Priority Data
Nov. 21, 2022 (FR) 2212115

(51) Int. Cl. A61C 1/08; A61C 8/00

(52) U.S. Cl. CPC A61C 1/084; A61C 8/0068; A61C 8/0089; A61C 2201/00

(57) ABSTRACT

A surgical guide system for the placement of dental implants includes a guide base attachable to the maxillary or mandibular bone, an aligner attachable to the base and to be positioned in the space relative to the reference tooth, teeth, or other anatomical landmarks remaining in the mouth, and a drilling guide attachable to the guide base and including at least one drill guide hole for guiding a drill. wherein the guide base: is substantially rigid; is resting mostly on the mucosa; is essentially matching the shape of a maxilla or a mandible and present a central part placed on the interior surface of the jaw, intended to provide lingual or palatal support, and is widely perforated along the maxillary or mandibular ridge, in order to allow past any teeth still present at the start of the operation or implants to be installed during the operation.

### CROSS REFERENCE TO RELATED APPLICATIONS

The present patent application claims the priority of French patent application FR 2212115 filed on Nov. 21, 2022, which is herein incorporated by reference.

### FIELD OF THE INVENTION

The current invention relates to a surgical guide for the placement of dental implants.

### PRIOR ART

The utilization of a surgical guide for the placement of dental implants is well known. The function of such a guide is to guide the practitioner, particularly when drilling the maxilla or mandibular bone, during the placement of one or more implants.

To ensure its proper function, such a guide must be positioned relative to an anatomical landmark that acts as a reference. In order to do this, a guide such as this is normally based on the remaining anatomical elements, typically the remaining teeth.

Now, this is not possible in the case of significant or complete edentulism. A guide such as this can also be based on anatomical elements outside of the mouth, such as the facial bones. However, this approach is normally very bulky and constitutes significant discomfort for the patient.

To overcome these difficulties, new strategies have been developed, including that described in U.S. Pat. No. 11,160,639. In this, there is described a method of placing a dental implant using a surgical guide comprising a base which is fixed directly on the vestibular face of the maxillary or mandibular bone, after removal of the overlapping gum. This base is then associated with an anatomical marker to adjust its positioning, before being coupled to a drilling guide which allows, after extraction of the teeth, to implant the pillars supporting the dental implant as accurately as possible. Now, this method requires strong expertise from the practitioner to correctly adjust the guide. To do this, the practitioner must, after removal of the gum, carry out a reduction of the bone to position the guide. The practitioner must then adapt the position of the base and, to do so, has a model to help him in this adjustment step. As a result, the implementation of such surgical guides each time constitutes a real challenge for the practitioner.

### SUMMARY OF THE INVENTION

The inventor has now developed a new surgical guide made to measure for a given patient, generally by 3D printing. The surgical guide rests perfectly on the mucous membranes of the palatal face in addition to the vestibular face with an opening at the level of the maxillary or mandibular crest to allow the extraction of teeth and the placement of implants and thus avoids open the gum widely to be put in place. The characteristics of the surgical guide thus developed also allowed perfect association of the guide on the mandible or maxilla in a simplified manner for the practitioner. The quality of this association was so good that it was almost equivalent to devices based on anatomical elements outside the mouth, such as the facial bones. Note that the quality of the association is such that it was not necessary to use screw or pin fixation on the palatal side of the base.

To accomplish this, the object of the invention is a surgical guide system for the placement of dental implants, comprising a guide base capable of being attached to the maxillary or mandibular bone, an aligner capable of being both attached to said base and positioned in the space relative to the reference tooth, teeth, or other anatomical landmarks remaining in the mouth, and a drilling guide capable of being attached to the base and comprising at least one drill guide hole, wherein the guide base:
is substantially rigid;
is resting mostly on the mucosa;
is essentially matching the shape of a maxilla or a mandible and present a central part placed on the interior surface of the jaw, intended to provide lingual or palatal support, and
is widely perforated along the maxillary or mandibular ridge, in order to allow past any teeth still present at the start of the operation or implants to be installed during the operation

Particular characteristics or embodiments, usable alone or in combination, include:
the guide base being attached to the bone using screws and/or pins;
the guide base being attached to the bone using screws and/or pins on the vestibular side only. The central part of the guide base placed on the internal face of the jaw which constitutes a lingual or palatal support does not include any fixation in the bone.
the drilling guide including, for each drill guide hole, a removable drill bushing that can snap into place;
the guide system also comprising a prosthesis capable of being attached to the guide base and having an access hole right in the position of each drill guide hole;
an access hole having a diameter greater than the clearance of the diameter of an abutment capable of being attached to an implant by one end and to the prosthesis by the other end;
the aligner being attached to the guide base by means of screws, the drilling guide being attached to the guide base by means of screws, and the prosthesis being attached to the guide base by means of screws;
the aligner, the drilling guide, and the prosthesis being alternately attached to the guide base, one at a time, essentially in place of one another, and having an essentially identical attachment interface, capable of being attached to a guide base one at a time;
the guide base being made of titanium, cobalt-chromium alloy, or class I or IIa biocompatible resin, the aligner being made of class I biocompatible resin, the drilling guide being made of titanium, cobalt-chromium alloy, or class I or IIa biocompatible resin, and the prosthesis being made of class IIa biocompatible resin.

According to a second aspect of the invention, a method of implementing such a guide system and of placing a dental implant comprises the following steps:
assembling the guide base and the aligner,
placing said assembly in the mouth, the aligner ensuring proper positioning of the assembly and therefore of the substantially rigid guide base resting mostly on the mucosa and essentially matching the shape of a maxilla or a mandible, which presents a central part placed on the interior surface of the jaw, intended to provide lingual or palatal support, and
attaching the guide base to the bone;
aligner removal;
possible tooth extraction;
attaching the drilling guide to the guide base;
drilling the bone;
placing the implants in the bone;
removing the drilling guide;
attaching the prosthesis to the guide base;
placing the abutments in the implants, preferably via screwing into said implants;
removing the guide base, and
attaching the prosthesis to the abutments, preferably by cementing it in place.

### BRIEF DESCRIPTION OF THE DRAWINGS

The invention may be better understood upon reading the following description, given solely by way of example, and with reference to the appended drawings in which:

FIG. 1 is a perspective view of a guide base,

FIG. 2 is a perspective view of an aligner,

FIG. 3 is a perspective view of the underside of the aligner illustrated in FIG. 2,

FIG. 4 is a perspective view of a drilling guide,

FIG. 5 is a perspective view of a drill bushing,

FIG. 6 is a perspective view of a prosthesis,

FIG. 7 is a top-down view of the prosthesis illustrated in FIG. 6,

FIG. 8 is a perspective view of the attachment of the aligner to the guide base,

FIG. 9 is a perspective view of the attachment of the drilling guide to the guide base, and

FIG. 10 is a perspective view of the attachment of the prosthesis to the guide base.

### DETAILED DESCRIPTION OF THE EMBODIMENTS

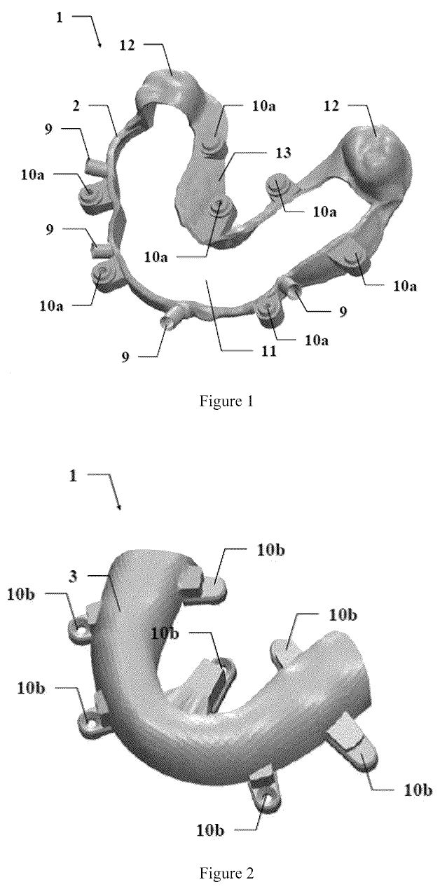

As illustrated in FIG. 1-7, the current invention relates to a surgical guide system 1 for the placement of dental implants.

It goes without saying that, herein, all the elements described are custom-made according to the specific measurements of the patient and their current anatomical and pathological condition.

The guide system 1 includes a guide base 2, an aligner 3, a drilling guide 4, and possibly a prosthesis 7, components that are generically known as stages.

The guide base 2, more particularly illustrated in FIG. 1, essentially matches the shape of a maxilla or a mandible of a given patient. It is widely perforated, with a large and noticeable gap 11, along the maxillary or mandibular ridge, in order to allow past any teeth still present at the start of the operation or implants to be installed during the operation.

In order to correctly ensure its reference function, taking up the anatomical frame of reference, the guide base 2 is rigid. Thus, the guide base 2 has a design close to a chassis.

Furthermore, in addition to the bone attachment points, said guide base rests as much as possible on the mucosa. As such, the guide base has a surface area of at least 50% resting on the mucous membranes, preferably a surface area of at least 60%. In this way, the guide base creates a solid base for the successive stages (4 and 7) of the guide system 1. Thus, its central part 13, i.e. the entire V arranged on the interior surface of the jaw, is more particularly intended to provide lingual support or palatal support. Typically, the lingual or palatal support has a surface similar to the vestibular support.

Note that, as far as possible, the guide base 2 also rests on teeth, to the extent that they remain. An example of such dental supports 12 is visible in FIG. 1.

The guide base 2 is capable of being attached to the maxillary or mandibular bone, typically by means of a first set of attachment points 9 and screws and/or pins.

The guide base 2 is intended to serve as a foundation for the surgical guide system 1 for the entire duration of the operation. The guide base 2 is intended to remain in place on the patient's jaw. It is therefore appropriate for the guide base 2 to be correctly positioned relative to one or more anatomical landmarks.

Now, the quality of the association of the guide base of the guide system of the invention with the mucous membranes of the maxilla or mandible of the patient is such that no fixation of the guide base to the bone is required on the palatal surface as shown in FIG. 1.

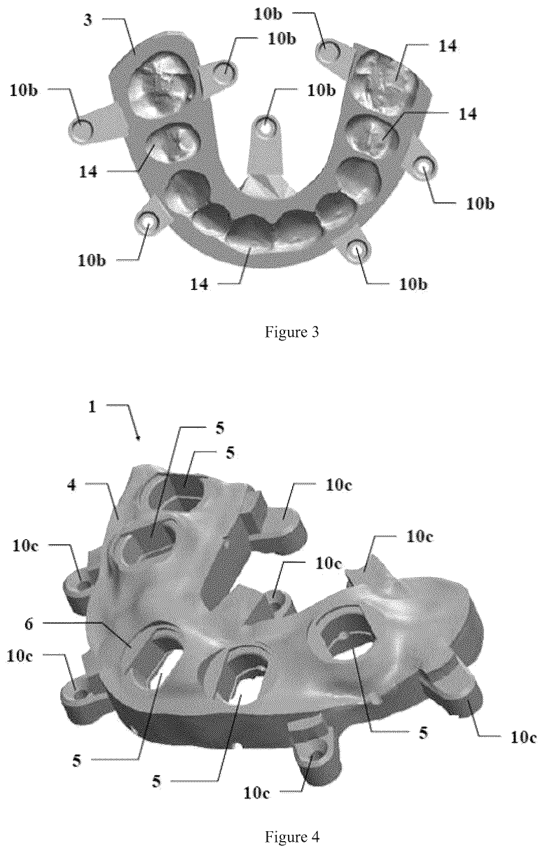

The positioning relative to one or more anatomical landmarks is accomplished via the aligner 3 (illustrated more specifically in FIGS. 2 and 3). In order to accomplish this, the aligner 3 is able to be attached to the guide base 2. Said attachment is typically achieved by means of a second set of attachment points 10-10a for the guide base 2, 10b for the aligner 3, 10c for the drilling guide 4, and 10d for the prosthesis 7.

The aligner 3 is capable of being positioned in the space in relation to the remaining tooth, teeth, or other anatomical landmarks in the mouth. For this, the aligner 3 comprises at least one negative mold 14 of the elements remaining in the mouth. These remaining elements may be teeth from the treated jaw, teeth from the opposite jaw, or any other element present in the mouth. Advantageously, as illustrated in FIGS. 2 and 3, the aligner 3 comprises at least one negative mold 14 of teeth intended to be extracted and replaced by the implant prosthesis.

As detailed further in the method of placing the surgical guide system 1, the aligner 3 is utilized and assembled with the guide base 2 at the start of the operation when the anatomical elements destined to be removed, such as the teeth to be extracted, are still present and can be used to position the aligner 3 relative to these impermanent anatomical elements and thus correctly position the guide base 2 in the mouth. The guide base 2, now properly positioned by the aligner 3 with which it is assembled by means of the second set of respective attachment points 10a and 10b, respectively, is then attached to the treated maxillary or mandibular bone by means of the first set of attachment points 9, preferably only on its vestibular face. Said attachment to the bone thus makes it possible to establish an anatomical frame of reference for the subsequent stages. The function of the aligner 3 is now complete; it can be removed and stored.

Once the aligner 3 is removed the drilling guide 4 can then be attached. Said drilling guide 4 (illustrated more specifically in FIG. 4) is capable of being attached to the guide base 2 by means of the second set of attachment points 10a and 10c. The drilling guide 4 is essentially attached in place of the aligner 3. The drilling guide 4 is thus positioned relative to the guide base 2 and thus relative to the correct anatomical frame of reference. The practitioner is now therefore certain to drill and place the implants in the correct position and along the correct axis. The drilling guide 4 comprises at least one drill guide hole 5. A drill guide hole 5 enables a drill to be guided while drilling the bone underlying the guide base 2 in order to properly place an implant. Also, the drilling guide 4 includes as many drill guide holes 5 as there are implants to be put in place.

It has been observed that the guide base 2 is capable of being attached to the maxillary or mandibular bone. Said attachment is achieved by means of the first set of attachment points 9. These attachment points 9 are designed to each accommodate a screw or pin. A screw is a surgical screw capable of being screwed into a bone. A pin is a surgical nail suitable for being driven into a bone. According to another characteristic, the guide base 2 is thus attached to the bone by means of screws, pins, or a combination of screws and pins.

Advantageously, the guide base 2 is attached to the bone by at least three attachment points/means/screws or pins. Preferably, the guide base does not include any point/means of attachment on its palatal side. Once attached thusly, the guide base 2 serves as a reference for the mounting of the different successive stages of the guide system 1: the drilling guide 4 and the prosthesis 7.

It has been observed that the aligner 3 is assembled with the guide base 2. This is achieved by means of attachment points 10a for the guide base and 10b for the aligner 3. According to another characteristic, in order to ensure a more secure attachment of the stages, the assembling is, at least for some of the means of attachment, performed by using screws.

Thus, the attachment points 10a, 10b, 10c, and 10d comprise plates capable of resting on/against an opposite, homologous plate and arranged facing an opposing plate on another stage. The attachment points 10a, 10b, 10c, and 10d can thus be simple supports or even supports with a coupling element, such as a screw screwed into two attachment points, each with an appropriately threaded hole through the aforementioned plates in order to receive said screw.

Similarly, the drilling guide 4 is attached to the guide base 2. This is achieved by way of the attachment points 10a for the guide base and 10c for the drilling guide 4. According to another characteristic, in order to ensure a more secure attachment of the stages to one another, the stages are attached to one another by using screws in at least some of the attachment points.

It has been observed that the drilling guide 4 comprises at least one drill guide hole 5 right in the position where an implant must be placed. A drill guide hole 5 is intended to guide the drill that is intended to drill the hole in the maxillary or mandibular bone that is intended to host an implant.

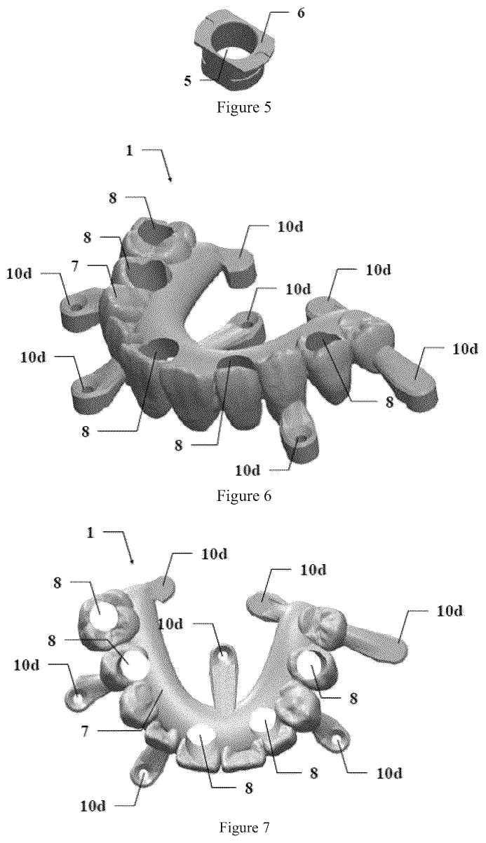

According to another characteristic, the drilling guide 4 comprises, for each drill guide hole 5, a drill bushing 6, illustrated more specifically in FIG. 5, that is removable, can snap into place, and is housed in a socket right at the position of the implant. Thus, the drill guide hole 5 can be made in either the material constituting the drilling guide 4 itself or in a drill bushing 6 in order to make said drill guide hole removable. The use of a drill bushing 6 makes it possible to change, at will, both the diameter of the drill guide hole 5 and the material used in said drill bushing in order to, for example, choose a harder material in order to resist abrasion by the drill or even to carry out a local surface treatment.

The guide system 1 as described above comprises a guide base 2, an aligner 3 for said base, and a drilling guide. A guide system 1 such as this is useful for the placement of implants.

Advantageously, the guide system 1 can also comprise a prosthesis 7. Such a prosthesis 7 is illustrated more specifically in FIGS. 6 and 7. This prosthesis 7 is able to be attached to the guide base 2. This is achieved by means of the second set of attachment points 10a for the guide base 2 and 10d for the prosthesis 7. In addition, the prosthesis 7 has an access hole 8 right in the position of each drill guide hole 5 or future implant.

Each access hole 8 allows an abutment to pass through the prosthesis 7. An abutment (not shown) is a substantially elongated rod, comprising, at one of its ends, an interface that is normally threaded and intended to be attached to an implant, while at the other of its ends lies an interface to be attached to a prosthesis via either glue or threading (screwed on/in). Each access hole 8 has the dimensions of the maximum size of the widest section of an abutment in order to allow passage.

According to another characteristic, an access hole 8 has a diameter identical to the diameter of an abutment, plus additional clearance. This additional clearance, as well as permitting the passage of an abutment through the prosthesis 7, provides a slight latitude in the positioning of the prosthesis 7, that permits, among other things, possible minor displacement in the positioning of implant abutments and thus helps to avoid issues in the settling of the prosthesis 7.

As can be deduced from the drawings and the preceding description, each of the upper stages, i.e., the aligner 3, the drilling guide 4, and the prosthesis 7, are alternately attached to the guide base 2, one at a time. Said attachments are carried out in essentially the same space. Furthermore, the guide base 2 presents a unique interface. Said interface is enabled by the second set of attachment points 10a. The upper stages, i.e., the aligner 3, the drilling guide 4, and the prosthesis 7, have an attachment interface that is essentially identical from one stage to another and is complementary to the interface of the guide base 2. Thus the second set of points 10b of the aligner 3, the second set of points 10c of the drilling guide 4, and the second set of points 10d of the prosthesis 7 are essentially identical to each, i.e., having the same positions and orientations.

In terms of materials, the guide base 2 is preferably made of titanium, cobalt-chromium alloy, or class I or IIa biocompatible resin.

The aligner 3 is preferably made of class I biocompatible resin.

The drilling guide 4 is preferably made of titanium, cobalt-chromium alloy, or class I or IIa biocompatible resin. This includes any drill bushings 6.

The prosthesis 7 is preferably made of class IIa biocompatible resin.

These fabrications are essentially unique pieces due to their customization, each being adapted to the individual patient, and would advantageously be manufactured by 3D printing or machining.

The current invention also relates to a method for installing such a guide system 1 and comprises the following steps.

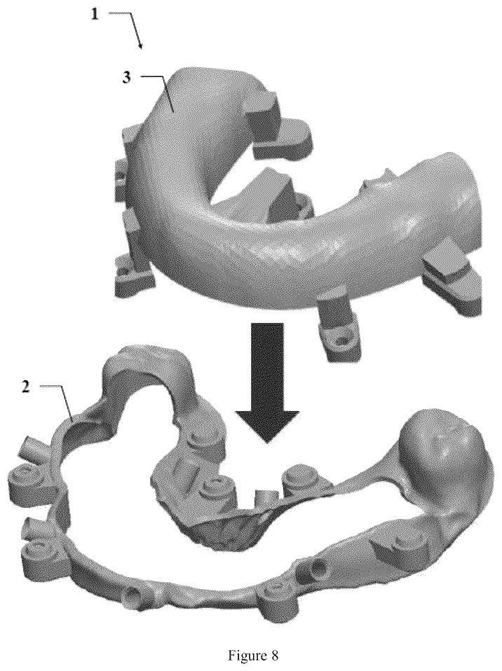

During the first step, the guide base 2 is assembled with the aligner 3, as illustrated in FIG. 8. This is achieved by means of the second set of respective attachment points 10a and 10b. Said assembly ensures precise relative positioning. Additionally, the two stages 2, 3 utilize the same frame of reference.

During the second step, the previous assembly is placed in the mouth. The aligner 3 ensures, during this step and in combination with the guide base, the proper positioning of the assembly, and thus the guide base 2, in relation to the reference tooth, teeth, or other anatomical landmarks remaining in the mouth. This is achieved mainly by means of the negative tooth mold 14 formed in the aligner 3 and corresponding typically to a tooth or teeth intended to be subsequently extracted.

According to another characteristic, the method further comprises the following steps. During the third step, the guide base 2 is attached to the bone, preferably on the vestibular side only. This is accomplished by means of the first set of attachment points 9 and the screws and/or pins traversing said attachment points 9.

Thanks to the aligner 3, which is positioned in relation to the anatomical dental landmarks, the guide base 2 is correctly placed. After its attachment to the bone, the guide base 2 serves as a reference for the subsequent operations.

Also, during the fourth step, the aligner 3 can be removed.

A fifth step possibly involves tooth extraction if teeth need to be extracted. Due to the large gap 11 in the guide base, these teeth are accessible through the guide base 2 itself.

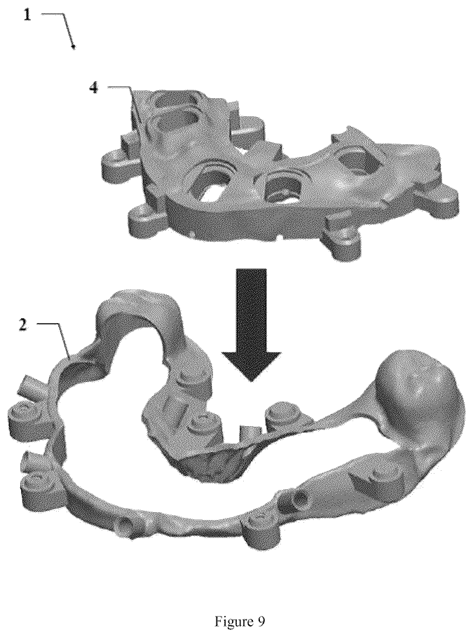

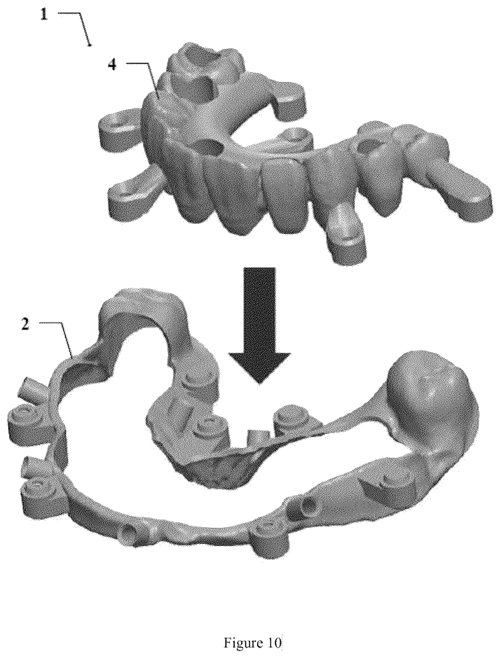

During a sixth step, the drilling guide 4 replaces the aligner 3 and is attached to the guide base 2, as illustrated in FIG. 9. Said attachment is achieved by means of the second set of respective attachment points 10a and 10c. This attachment ensures precise relative positioning. Also, the two stages 2, 4 utilize the same frame of reference.

During the seventh step the bone is drilled as the practitioner uses the drill guide holes 5 of the drilling guide 4 to guide the drill.

The eighth step sees the placement of the implants in the bone.

Then, during the ninth step, the drilling guide 4 can be removed.

During the tenth step, the prosthesis 7 replaces the drilling guide 4 and is attached to the guide base 2, as illustrated in FIG. 10. Said attachment is achieved by means of the second set of respective attachment points 10a and 10d. This assembly ensures precise relative positioning. Also, the two stages 2, 7 utilize the same frame of reference.

The eleventh step sees the installation of the abutments and their assembly with the implants. This is preferably done by screwing said abutments into said implants.

The twelfth step corresponds to the removal of the guide base 2 and the fixing of the prosthesis 7 alone to the abutments, preferably by being cemented in place.

The prosthesis 7 is now firmly attached to the implants and the guide base 2.

The invention has been illustrated and described in detail in the drawings and the preceding description. This should be considered illustrative and given by way of example and not as limiting the invention to this description alone. Numerous embodiment variants are possible.

### LIST OF REFERENCE TERMS

1: Surgical guide system
2: Guide base
3: Aligner
4: Drilling guide
5: Drill guide hole
6: Drill bushing
7: Prosthesis
8: Access hole
9: First set of attachment points
10a: Second set of guide base attachment points
10b: Second set of aligner attachment points
10c: Second set of drilling guide attachment points
10d: Second set of prosthesis attachment points
11: Gap
12: Dental support
13: Lingual or palatal support
14: Negative tooth mold

1. A surgical guide system for the placement of dental implants comprising a guide base capable of being attached to the maxillary or mandibular bone, an aligner capable of being attached to the guide base and of being positioned in the mouth relative to the remaining reference tooth, teeth, or other anatomical landmarks, and a drilling guide capable of being attached to the guide base and comprising at least one drill guide hole for guiding a drill, wherein the guide base:
is substantially rigid;
is resting mostly on the mucosa;
is essentially matching the shape of a maxilla or a mandible and present a central part placed on the interior surface of the jaw, intended to provide lingual or palatal support, and
is widely perforated along the maxillary or mandibular ridge, in order to allow past any teeth still present at the start of the operation or implants to be installed during the operation.

2. The guide system of claim 1, wherein the guide base is attached to the bone by means of screws and/or pins.

3. The guide system of claim 2, wherein the central part of the guide base placed on the internal face of the jaw and constituting a lingual or palatal support does not include any fixation in the bone.

4. The guide system of claim 1, wherein the drilling guide comprises a removable drill bushing that can snap into place for each drill guide hole.

5. The guide system of claim 1, further comprising a prosthesis capable of being attached to the guide base and having an access hole right at the position of each drill guide hole.

6. The guide system of claim 5, wherein the access hole has a diameter greater than the diameter of an abutment; said abutment being capable of attaching to an implant by one end and to the prosthesis by the other end.

7. The guide system of claim 5, wherein the aligner is attached to the guide base by means of screws, the drilling guide is attached to the guide base by means of screws and the prosthesis is attached to the guide base by means of screws.

8. The guide system of claim 5, wherein the aligner, the drilling guide, and the prosthesis, are alternately attached to the guide base, one at a time, essentially in place of one another and have an essentially identical attachment interface that is capable of being attached to a similar interface on the guide base.

9. The guide system of claim 5, wherein the guide base is made of titanium, a cobalt-chromium alloy, or of class I or IIa biocompatible resin, the aligner is made of class I biocompatible resin, the drilling guide is made of titanium, cobalt-chromium alloy, or class I or IIa biocompatible resin, and the prosthesis is made of class IIa biocompatible resin.

10. A method of implementing the guide system as defined in claim 1 and of placing a dental implant comprising the following steps:
assembling the guide base and the aligner,
placing said assembly in the mouth, the aligner ensuring proper positioning of the assembly and therefore of the substantially rigid guide base resting mostly on the mucosa and essentially matching the shape of a maxilla or a mandible, which presents a central part placed on the interior surface of the jaw, intended to provide lingual or palatal support, and
attaching the guide base to the bone;
aligner removal;
possible tooth extraction;
attaching the drilling guide to the guide base;
drilling the bone;
placing the implants in the bone;
removing the drilling guide;
attaching the prosthesis to the guide base;
placing the abutments in the implants;
removing the guide base, and
attaching the prosthesis to the abutments.

11. The method of claim 10, wherein placing the abutments in the implants is performed via screwing into said implants.

12. The method of claim 11, wherein attaching the prosthesis to the abutments is performed by cementing the prosthesis in place.

13. A method of implementing the guide system as defined in claim 2 and of placing a dental implant comprising the following steps:
assembling the guide base and the aligner,
placing said assembly in the mouth, the aligner ensuring proper positioning of the assembly and therefore of the substantially rigid guide base resting mostly on the mucosa and essentially matching the shape of a maxilla or a mandible, which presents a central part placed on the interior surface of the jaw, intended to provide lingual or palatal support, and
attaching the guide base to the bone;
aligner removal;
possible tooth extraction;
attaching the drilling guide to the guide base;
drilling the bone;
placing the implants in the bone;
removing the drilling guide;
attaching the prosthesis to the guide base;
placing the abutments in the implants;
removing the guide base, and
attaching the prosthesis to the abutments.

14. A method of implementing the guide system as defined in claim 3 and of placing a dental implant comprising the following steps:
assembling the guide base and the aligner,
placing said assembly in the mouth, the aligner ensuring proper positioning of the assembly and therefore of the substantially rigid guide base resting mostly on the mucosa and essentially matching the shape of a maxilla or a mandible, which presents a central part placed on the interior surface of the jaw, intended to provide lingual or palatal support, and
attaching the guide base to the bone;
aligner removal;
possible tooth extraction;
attaching the drilling guide to the guide base;
drilling the bone;
placing the implants in the bone;
removing the drilling guide;
attaching the prosthesis to the guide base;
placing the abutments in the implants;
removing the guide base, and
attaching the prosthesis to the abutments.

15. A method of implementing the guide system as defined in claim 4 and of placing a dental implant comprising the following steps:
assembling the guide base and the aligner,
placing said assembly in the mouth, the aligner ensuring proper positioning of the assembly and therefore of the substantially rigid guide base resting mostly on the mucosa and essentially matching the shape of a maxilla or a mandible, which presents a central part placed on the interior surface of the jaw, intended to provide lingual or palatal support, and
attaching the guide base to the bone;
aligner removal;
possible tooth extraction;
attaching the drilling guide to the guide base;
drilling the bone;
placing the implants in the bone;
removing the drilling guide;
attaching the prosthesis to the guide base;
placing the abutments in the implants;
removing the guide base, and
attaching the prosthesis to the abutments.

16. A method of implementing the guide system as defined in claim 5 and of placing a dental implant comprising the following steps:
assembling the guide base and the aligner,
placing said assembly in the mouth, the aligner ensuring proper positioning of the assembly and therefore of the substantially rigid guide base resting mostly on the mucosa and essentially matching the shape of a maxilla or a mandible, which presents a central part placed on the interior surface of the jaw, intended to provide lingual or palatal support, and
attaching the guide base to the bone;
aligner removal;
possible tooth extraction;
attaching the drilling guide to the guide base;
drilling the bone;
placing the implants in the bone;
removing the drilling guide;
attaching the prosthesis to the guide base;
placing the abutments in the implants;
removing the guide base, and
attaching the prosthesis to the abutments.

17. A method of implementing the guide system as defined in claim 6 and of placing a dental implant comprising the following steps:
assembling the guide base and the aligner,
placing said assembly in the mouth, the aligner ensuring proper positioning of the assembly and therefore of the substantially rigid guide base resting mostly on the mucosa and essentially matching the shape of a maxilla or a mandible, which presents a central part placed on the interior surface of the jaw, intended to provide lingual or palatal support, and
attaching the guide base to the bone;
aligner removal;
possible tooth extraction;
attaching the drilling guide to the guide base;
drilling the bone;
placing the implants in the bone;
removing the drilling guide;
attaching the prosthesis to the guide base;
placing the abutments in the implants;
removing the guide base, and
attaching the prosthesis to the abutments.

18. A method of implementing the guide system as defined in claim 7 and of placing a dental implant comprising the following steps:
assembling the guide base and the aligner,
placing said assembly in the mouth, the aligner ensuring proper positioning of the assembly and therefore of the substantially rigid guide base resting mostly on the mucosa and essentially matching the shape of a maxilla or a mandible, which presents a central part placed on the interior surface of the jaw, intended to provide lingual or palatal support, and
attaching the guide base to the bone;
aligner removal;
possible tooth extraction;
attaching the drilling guide to the guide base;
drilling the bone;
placing the implants in the bone;
removing the drilling guide;
attaching the prosthesis to the guide base;
placing the abutments in the implants;
removing the guide base, and
attaching the prosthesis to the abutments.

19. A method of implementing the guide system as defined in claim 8 and of placing a dental implant comprising the following steps:
assembling the guide base and the aligner,
placing said assembly in the mouth, the aligner ensuring proper positioning of the assembly and therefore of the substantially rigid guide base resting mostly on the mucosa and essentially matching the shape of a maxilla or a mandible, which presents a central part placed on the interior surface of the jaw, intended to provide lingual or palatal support, and
attaching the guide base to the bone;
aligner removal;
possible tooth extraction;
attaching the drilling guide to the guide base;
drilling the bone;
placing the implants in the bone;
removing the drilling guide;
attaching the prosthesis to the guide base;
placing the abutments in the implants;
removing the guide base, and
attaching the prosthesis to the abutments.

20. A method of implementing the guide system as defined in claim 9 and of placing a dental implant comprising the following steps:
assembling the guide base and the aligner,
placing said assembly in the mouth, the aligner ensuring proper positioning of the assembly and therefore of the substantially rigid guide base resting mostly on the mucosa and essentially matching the shape of a maxilla or a mandible, which presents a central part placed on the interior surface of the jaw, intended to provide lingual or palatal support, and
attaching the guide base to the bone;
aligner removal;
possible tooth extraction;
attaching the drilling guide to the guide base;
drilling the bone;
placing the implants in the bone;
removing the drilling guide;
attaching the prosthesis to the guide base;
placing the abutments in the implants;
removing the guide base, and
attaching the prosthesis to the abutments.
